(19) United States
(12) Patent Application Publication
(10) Pub. No.: US 2014/0040680 A1
(43) Pub. Date: Feb. 6, 2014

(54) MEMORY CONTROL DEVICE AND CONTROL METHOD

(71) Applicant: FUJITSU LIMITED, Kawasaki-shi (JP)

(72) Inventors: Kazuya TAKAKU, Kawasaki (JP); Hiroshi NAKAYAMA, Yokohama (JP); Hideyuki SAKAMAKI, Yokohama (JP); Hidekazu OSANO, Hachioji (JP); Masanori HIGETA, Setagaya (JP)

(73) Assignee: FUJITSU LIMITED, Kawasaki-shi (JP)

(21) Appl. No.: 14/060,676

(22) Filed: Oct. 23, 2013

Related U.S. Application Data
(63) Continuation of application No. PCT/JP2011/063608, filed on Jun. 14, 2011.

(51) Int. Cl. G06F 11/08

(52) U.S. Cl. CPC G06F 11/08
USPC 714/54

(57) ABSTRACT

A memory controller receives a read request and also issues a patrol request at a predetermined time interval so as to determine whether any error occurs in data stored in a DIMM. Furthermore, the memory controller generates a patrol address that is the subject of the subsequently issued patrol request. When the memory controller receives a read request, the memory controller compares the patrol address with the read address that is the subject of the received read request. When the read address matches the patrol address, the memory controller cancels the issuance of the subsequent patrol request.

### CROSS-REFERENCE TO RELATED APPLICATION

This application is a continuation of International Application No. PCT/JP2011/063608, filed on Jun. 14, 2011 and designating the U.S., the entire contents of which are incorporated herein by reference.

### FIELD

The embodiments discussed herein are related to a memory control device and a control method.

### BACKGROUND

There are conventionally-known technologies for memory control devices that control reading of data that is stored in a memory and controls writing of data to a memory. As an example of such control devices, memory controllers have been known which correct errors in data stored in the memory at a certain time interval so as to prevent the occurrence of uncorrectable errors.

This type of memory controllers perform, before the memory is accessed by the operating system (OS) or applications, a patrol operation at a certain time interval to read data stored in the memory and detect any error in the data. Here, the memory controller performs the patrol operation with priority over a data reading operation or writing operation in order to prevent the occurrence of uncorrectable errors during data reading. If any error is detected during the patrol operation, the memory controller performs a scrub operation to read data that is stored in the memory, correct the error in the read data, and store the corrected data in the memory again.

Thus, the memory controller performs the patrol operation at a certain time interval so as to prevent the error occurring in the data stored in the memory from becoming an uncorrectable error due to transmission errors, or the like, during data reading.

An explanation is given below, with reference to the drawing, of an example of a memory controller that performs the patrol operation. FIG. 13 is a diagram that illustrates a related memory controller. In the example illustrated in FIG. 13, a memory controller 40 is connected to a chip set 41 and a Dual Inline Memory Module (DIMM) 42. Furthermore, the memory controller 40 includes a patrol control unit 43, a buffer 44, a scrub control unit 45, an arbiter 46, an error checker 47, an error correction unit 48, and an arbiter 49.

The chip set 41 issues a read request and a write request for data that is stored in the DIMM 42. Moreover, the chip set 41 sets the enable signal for the patrol control unit 43 to “ON” if the function of the patrol operation performed by the memory controller 40 is to be valid. The DIMM 42 stores data to which an error correction code (ECC) is assigned.

When the enable signal is “ON”, the patrol control unit 43 issues a patrol request so as to request the patrol operation to be performed at a certain time interval. The buffer 44 is a buffer that temporarily stores a read request and a write request that are issued by the chip set 41. When the scrub control unit 45 receives, from the error checker 47, a notification that an error has been detected, the scrub control unit 45 issues a scrub read request to read again the data from which the error has been detected and correct the error in the read data and issues a scrub write request to store the error-corrected data in the DIMM 42.

The scrub read request and scrub write request need to be performed in an atomic manner so that the coincidence of data stored in the DIMM 42 is ensured. When the scrub control unit 45 receives a notification that an error has been detected from the error checker 47, the scrub control unit 45 stops the patrol control unit 43 and the buffer 44 from issuing requests and then issues a scrub read request and a scrub write request. At the same time that the scrub control unit 45 issues a scrub write request, the scrub control unit 45 requests the arbiter 49 to transmit the error-corrected data.

The arbiter 46 is an arbiter that issues the requests that are issued by the patrol control unit 43, the buffer 44, and the scrub control unit 45, where the requests are given priority in the following order: scrub read requests, scrub write requests, patrol requests, read requests, and then write requests. The error checker 47 uses ECCs to detect any error in the data read from the DIMM 42. When any error is detected, the error checker 47 transmits, to the scrub control unit 45 and the error correction unit 48, a notification that an error has been detected.

When the error correction unit 48 receives, from the error checker 47, a notification that an error has been detected, the error correction unit 48 determines whether the data from which an error has been detected is the data associated with a patrol request, the data associated with a read request, or the data associated with a scrub read request. If the error correction unit 48 determines that the data from which an error has been detected is the data associated with a patrol request, the error correction unit 48 discards the data.

Furthermore, if the data from which an error has been detected is the data associated with a read request, the error correction unit 48 corrects the error and transmits the error-corrected data to the chip set 41. Moreover, if the data from which an error has been detected is the data associated with a scrub read request, the error correction unit 48 corrects the error and transmits the error-corrected data to the arbiter 49.

The arbiter 49 receives, from the chip set 41, the data associated with a write request. Furthermore, the arbiter 49 receives, from the error correction unit 48, data in which an error has been corrected. When the arbiter 46 issues a write request, the arbiter 49 sends the data received from the chip set 41. When the scrub control unit 45 requests the error-corrected data to be transmitted, the arbiter 49 transmits, to the DIMM 42, the data received from the error correction unit 48.

FIG. 14 is a diagram that illustrates an example of the patrol control unit. In the example illustrated in FIG. 14, the patrol control unit 43 includes an issuance interval timer 50 and a patrol-address generation unit 51. When the enable signal is “ON”, the issuance interval timer 50 issues a timing notification to the patrol-address generation unit 51 at a certain time interval and also outputs a valid bit that indicates the issuance of a patrol request.

The patrol-address generation unit 51 generates a memory address that is a target of patrol, i.e., a patrol address, in advance and stores the generated patrol address. When the patrol-address generation unit 51 receives a timing notification from the issuance interval timer 50, the patrol-address generation unit 51 outputs the stored patrol address. That is, the patrol-address generation unit 51 outputs the patrol address together with the valid that is output from the issuance interval timer 50, thereby issuing a patrol request to the arbiter 46. Moreover, when the patrol-address generation unit 51 outputs the patrol address, the patrol-address generation unit 51 generates a new patrol address and stores the generated patrol address.

FIG. 15 is a flowchart that illustrates a related process to issue a patrol request. For example, when it is time to issue a patrol request (Yes at Step S1), the patrol control unit 43 issues a patrol request for the patrol address that is generated in advance (Step S2). The patrol control unit 43 then generates a patrol address that is the subject of the subsequently issued patrol request (Step S3). Conversely, when it is not time to issue a patrol request (No at Step S1), the patrol control unit 43 stands by without issuing any patrol requests.

FIG. 16 is a chart that illustrates the time in which the patrol control unit issues a patrol request. The thick lines in FIG. 16 indicate the time in which each communication and request is sent. As illustrated in FIG. 16, the issuance interval timer 50 transmits a timing notification and a patrol valid at a certain time interval. Furthermore, each time the issuance interval timer 50 transmits a timing notification, the patrol-address generation unit 51 generates a different memory address and stores it. Thus, the patrol control unit 43 issues patrol requests for different memory addresses at certain time intervals.

Patent Document 1: Japanese Laid-open Patent Publication No. 04-119442

Patent Document 2: Japanese Laid-open Patent Publication No. 2005-050346

However, according to the above-described technology in which the patrol operation is performed at a certain time interval, the patrol operation is performed with priority over the data reading operation; therefore, memory accesses associated with a data reading operation or writing operation are interrupted. As a result, there is a problem of a decrease in the system performance.

For example, the memory controller 40 performs a patrol on each of the memory addresses included in the DIMM 42 once a day so as to prevent errors in the data stored in the DIMM 42 from becoming uncorrectable errors. However, in accordance with an increase in the size of the DIMM 42, the number of patrol requests issued per day increases; therefore, the interval at which patrol requests are issued becomes shorter. As a result, the memory controller 40 causes an increase in the number of times the memory is accessed in accordance with patrol requests and therefore causes a decrease in the performance of memory accesses in accordance with read requests and write requests.

Moreover, the memory controller 40 performs a patrol operation at a certain time interval so as to handle with the rate at which errors occur. Therefore, if the memory controller 40 performs the patrol operation collectively during a time period in which read requests and write requests are issued infrequently, it is difficult to achieve an object for preventing uncorrectable errors.

It is possible to perform an operation to cancel execution of the scrub operation when a read request or write request is received, whereby the number of times the memory is accessed in accordance with read requests or write requests can be improved. However, if the execution of a scrub operation is canceled, the rate at which uncorrectable errors occur can be higher and therefore the rate at which the system down occurs due to DIMM errors can be degraded.

### SUMMARY

According to an aspect of the embodiments, a memory control device includes: a receiving unit that receives a read request for data that is stored in a storage device; and a checking read request issuing unit that issues a checking read request at a predetermined time interval to request the data to be read so as to determine whether an error occurs in the data stored in the storage device. The checking read request issuing unit includes: an address generation unit that generates a memory address that is a subject of a subsequently issued checking read request; an issuing unit that issues a checking read request for the memory address generated by the address generation unit at a predetermined time interval; an address acquisition unit that acquires a memory address that is a subject of a read request received by the receiving unit; and a canceling unit that compares the memory address generated by the address generation unit with the memory address acquired by the address acquisition unit and, when the memory addresses match, causes the issuing unit to cancel issuance of a checking read request for the memory address.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram that illustrates a system board according to a first embodiment;

FIG. 2 is a diagram that illustrates a bridge chip according to the first embodiment;

FIG. 3 is a diagram that illustrates an example of a memory controller according to the first embodiment;

FIG. 4 is a diagram that illustrates an example of a patrol control unit according to the first embodiment;

FIG. 5 is a timing chart that illustrates the time in which the patrol control unit according to the first embodiment issues a patrol request;

FIG. 6 is a diagram that illustrates an example of the process performed by an arbiter according to the first embodiment;

FIG. 7 is a flowchart that illustrates the flow of the process performed by the memory controller according to the first embodiment;

FIG. 8 is a flowchart that illustrates the process performed by the memory controller according to the first embodiment to cancel a patrol request;

FIG. 9 is a diagram that illustrates a patrol control unit according to a second embodiment;

FIG. 10 is a diagram that illustrates an example of an address buffer circuit according to the second embodiment;

FIG. 11 is a chart that illustrates an example of the flow of the process performed by the patrol control unit according to the second embodiment to store a read address in a buffer;

FIG. 12 is a chart that illustrates an example of the flow of the process performed by the patrol control unit according to the second embodiment to determine whether the issuance of a patrol request is to be canceled;

FIG. 13 is a diagram that illustrates a related memory controller;

FIG. 14 is a diagram that illustrates an example of the patrol control unit;

FIG. 15 is a flowchart that illustrates a related process to issue a patrol request; and

FIG. 16 is a chart that illustrates the time in which a patrol control unit issues a patrol request.

### DESCRIPTION OF EMBODIMENTS

Preferred embodiments will be explained with reference to accompanying drawings.

### [a] First Embodiment

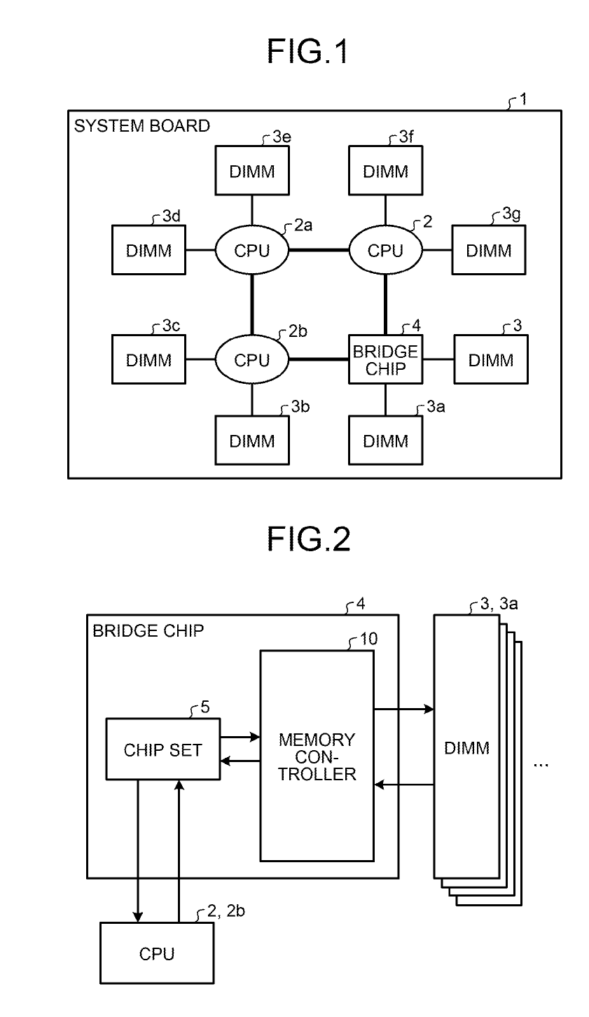

In a first embodiment that is described below, an explanation is given, with reference to FIG. 1, of an example of a system board that includes a memory controller that is an example of the memory control device. FIG. 1 is a diagram that illustrates a system board according to the first embodiment.

As illustrated in FIG. 1, a system board 1 includes a plurality of CPUs 2 to 2b and a bridge chip 4. Furthermore, the system board 1 includes a plurality of DIMMs 3 to 3g. The DIMMs 3 and 3a are connected to the bridge chip 4, the DIMMs 3b and 3c are connected to the CPU 2b, the DIMMs 3d and 3e are connected to the CPU 2a, and the DIMM 3f and 3g are connected to the CPU 2. An error correction code (ECC) is attached to data stored in each of the DIMMs 3 to 3g so as to detect an error and correct a 1-bit error.

In the above-described system board 1, each of the CPUs 2 to 2b is capable of writing and reading data to and from not only the DIMMs that are connected thereto but also the DIMMs that are connected to other CPUs and the bridge chip 4. For example, when the CPU 2 is to write and read data to and from the DIMM 3 that is connected to the bridge chip 4, the CPU 2 transmits, to the bridge chip 4, a read request to request data to be read or a write request to request data to be written. When the CPUs 2 to 2b transmit a write request, the CPUs 2 to 2b transmit the data to be written in the memory as well as the write request.

When the bridge chip 4 receives a read request from the CPUs 2 to 2b, the bridge chip 4 reads, from the DIMMs 3 and 3a, the data that is a target of the read request and then transmits the read data to the CPU that is the requester. Furthermore, when the bridge chip 4 receives, from the CPUs 2 to 2b, a write request and the data to be written, the bridge chip 4 writes the received data in the DIMMs 3 and 3a.

Here, the bridge chip 4 performs a patrol operation at a certain time interval so as to prevent a case where an error occurs in the data stored in the DIMMs 3 and 3a and, while the data having the error is read, another error is added to the data and therefore an uncorrectable error occurs. Specifically, the bridge chip 4 generates a memory address of the DIMMs 3 and 3a to be patrolled and then issues a patrol request for the generated memory address at a certain time interval. If no error has been detected from the read data, the bridge chip 4 discards the read data. If any error has been detected from the read data, the bridge chip 4 issues a scrub read request and a scrub write request. Afterward, the bridge chip 4 corrects the data that is read in accordance with the scrub read request and then stores the corrected data in the memory in accordance with a scrub write request.

With reference to the drawing, an explanation is given below of the bridge chip 4 according to the first embodiment. FIG. 2 is a diagram that illustrates the bridge chip according to the first embodiment. In the example illustrated in FIG. 2, the bridge chip 4 includes a chip set 5 and a memory controller 10. The chip set 5 receives a read request or write request from the CPUs 2 to 2b and then transmits the received read request or write request to the memory controller 10.

When the chip set 5 receives, from the memory controller 10, the data for a read request, the chip set 5 transmits the received data to the CPU (e.g., the CPU 2) that has transmitted the read request. Furthermore, when the chip set 5 receives a write request and the data to be written in the DIMMs 3 and 3a, the chip set 5 transmits the write request and the data to the memory controller 10.

Moreover, the chip set 5 causes the memory controller 10 to perform the patrol operation on the data stored in the DIMMs 3 and 3a so that correctable errors are prevented from becoming uncorrectable errors. Specifically, there is an enable line between the chip set 5 and the memory controller 10, and the chip set 5 continuously inputs “High” via the enable line while the chip set 5 causes the memory controller 10 to perform the patrol operation. To stop the patrol operation, the chip set 5 continuously inputs “Low” via the enable line.

The memory controller 10 issues a patrol request for the previously generated memory address at a certain time interval. Furthermore, the memory controller 10 generates a memory address for the subsequently issued patrol request at a certain time interval. When the memory controller 10 receives a read request, the memory controller 10 acquires the memory address that is the subject of the read request. Moreover, the memory controller 10 compares the generated memory address with the memory address that is the subject of the read request. If the memory address that is the subject of the read request matches the generated memory address, the memory controller 10 cancels the issuance of a patrol request.

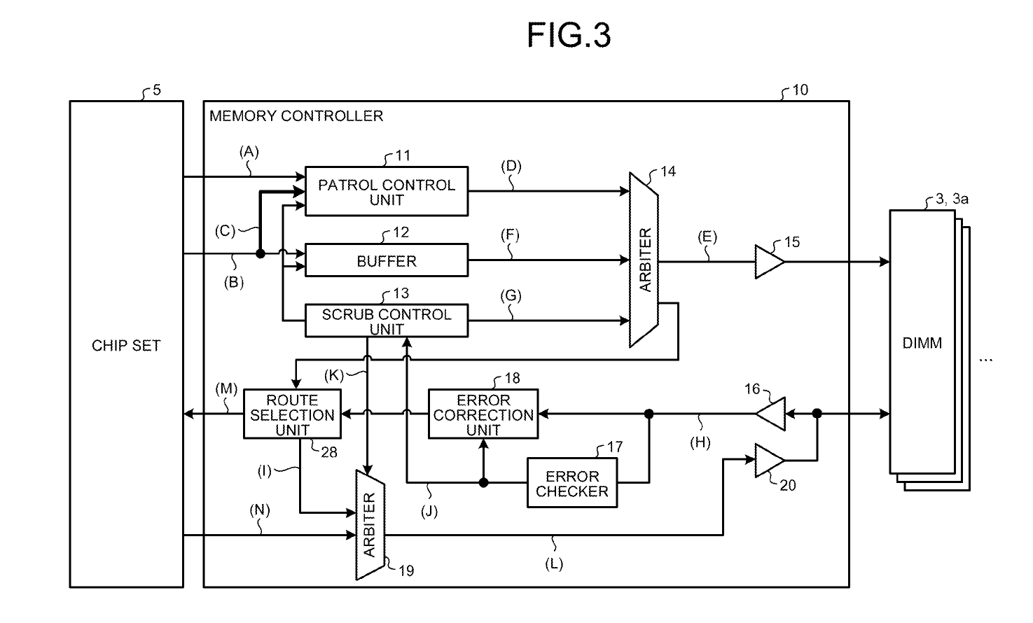

An explanation is given below, with reference to the drawing, of an example of the memory controller 10 according to the first embodiment. FIG. 3 is a diagram that illustrates an example of the memory controller according to the first embodiment. In the example illustrated in FIG. 3, the memory controller 10 includes a patrol control unit 11, a buffer 12, a scrub control unit 13, an arbiter 14, buffers 15, 16, 20, an error checker 17, an error correction unit 18, an arbiter 19, and a route selection unit 28.

The memory controller 10 inputs the enable signal received from the chip set 5 to the patrol control unit 11 via the enable line indicated by (A) in FIG. 3. Furthermore, the memory controller 10 stores the read request received from the chip set 5 in the buffer 12 via the route indicated by (B) in FIG. 3. Here, a read request includes a read command that indicates that the type of operation requested is reading and includes a read address that is a memory address to be read.

Furthermore, the memory controller 10 transmits the read request received from the chip set 5 to the patrol control unit 11 via the route indicated by (C) in FIG. 3. That is, the memory controller 10 transmits the read command and the read address to the patrol control unit 11.

The patrol control unit 11 issues a patrol request at a certain time interval when the enable signal “High” is input from the chip set 5 via the enable line indicated by (A) in FIG. 3. The patrol control unit 11 does not issue a patrol request when the enable signal “Low” is input.

Furthermore, the patrol control unit 11 generates a memory address that is the subject of the subsequently issued patrol request at a certain time interval. The patrol control unit 11 issues a patrol request for the generated memory address to the arbiter 14 via the route indicated by (D) in FIG. 3 at a certain time interval. Moreover, the patrol control unit 11 acquires the received read request via the route indicated by (C) in FIG. 3 and acquires the memory address for the acquired read request.

The patrol control unit 11 then compares the generated memory address with the acquired memory address for the read request. If both memory addresses match, the patrol control unit 11 cancels the issuance of the subsequent patrol request. Specifically, if the patrol control unit 11 receives a read request for the memory address that is identical to the memory address for the subsequent patrol request during the time period from when the memory address for the subsequent patrol request is generated to when a patrol request is issued, the patrol control unit 11 cancels the issuance of the patrol request.

Furthermore, the patrol control unit 11 stops issuing patrol requests if the patrol control unit 11 receives, from the scrub control unit 13, a notification that the issuance of requests is prohibited. When the patrol control unit 11 receives, from the scrub control unit 13, a notification that the prohibition of issuance of requests is cancelled, the patrol control unit 11 starts to issue a patrol request again. The patrol control unit 11 withdraws the issuance of a patrol request if the patrol control unit 11 issues the patrol request to the arbiter 14 and then receives, from the arbiter 14, “Taken” that indicates that each request has been performed.

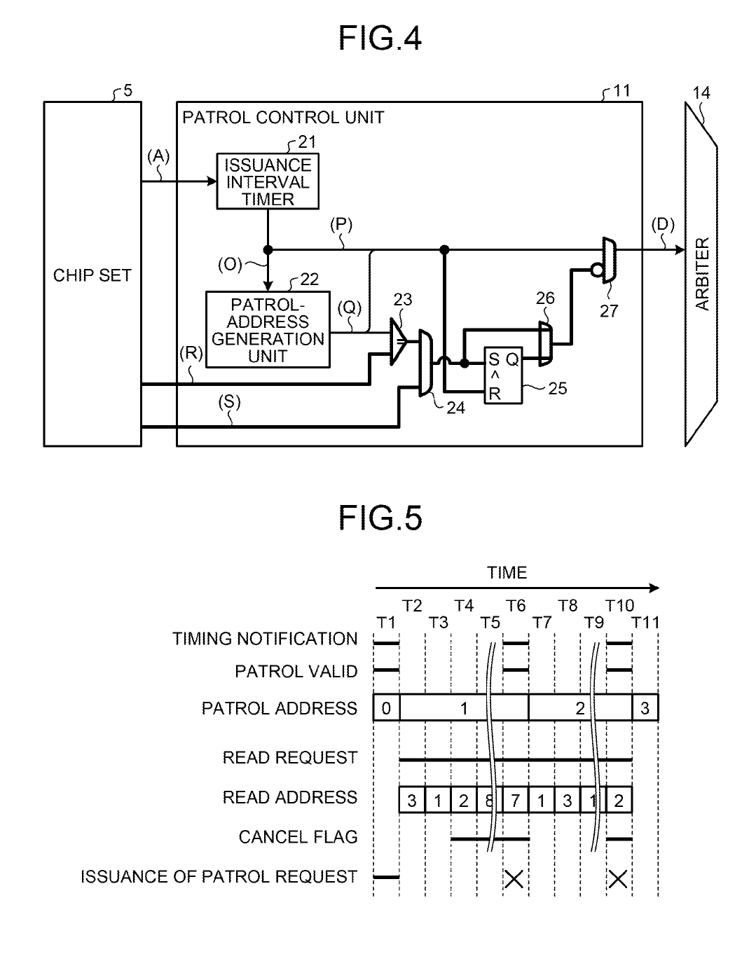

Next, an explanation is given, with reference to FIG. 4, of an example of the patrol control unit 11.

FIG. 4 is a diagram that illustrates an example of the patrol control unit according to the first embodiment. In the example illustrated in FIG. 4, the patrol control unit 11 includes an issuance interval timer 21, a patrol-address generation unit 22, a comparator 23, an AND gate 24, an RS flip-flop 25, an OR gate 26, and an AND gate 27. The routes indicated by (A) and (D) in FIG. 4 correspond to the routes indicated by (A) and (D) in FIG. 3, and the routes indicated by (R) and (S) in FIG. 4 correspond to the route indicated by (C) in FIG. 3.

In the example illustrated in FIG. 4, the patrol control unit 11 inputs an enable signal to the issuance interval timer 21 via the route indicated by (A) in FIG. 4. Furthermore, in the example illustrated in FIG. 4, the patrol control unit 11 inputs a read address to the comparator 23 via the route indicated by (R) in FIG. 4 and inputs a read command to the AND gate 24 via the route indicated by (S) in FIG. 4. Here, the read command is used as a valid that indicates that a read request has been received.

As indicated by (O) in FIG. 4, the issuance interval timer 21 transmits a timing notification to the patrol-address generation unit 22 at a certain time interval if the enable signal is “High”. Furthermore, at the same time that the issuance interval timer 21 issues the timing notification, the issuance interval timer 21 issues a patrol valid that indicates that a patrol request has been issued and then inputs the patrol valid to the AND gate 27, as indicated by (P) in FIG. 4.

The patrol-address generation unit 22 generates a patrol address, i.e., a memory address for the subsequently issued patrol request, at a certain time interval. When the patrol-address generation unit 22 generates a new patrol address, the patrol-address generation unit 22 generates a patrol address that is different from the previously generated patrol address. Specifically, when the patrol-address generation unit 22 receives a timing notification from the issuance interval timer 21, the patrol-address generation unit 22 increments the previously generated patrol address by “1” so as to generate a patrol address. The patrol-address generation unit 22 then continuously outputs the generated patrol address via the route indicated by (Q) in FIG. 4. Furthermore, when the patrol-address generation unit 22 receives a timing notification from the issuance interval timer 21, the patrol-address generation unit 22 inputs, to the AND gate 27, the previously generated patrol address together with the patrol valid.

The comparator 23 compares the patrol address generated by the patrol-address generation unit 22 with the read address acquired via the route indicated by (R) in FIG. 4. If the patrol address matches the read address, the comparator 23 outputs “1” to the AND gate 24. The AND gate 24 performs an AND operation on the read valid received via the route indicated by (S) in FIG. 4 and the output from the comparator 23 and then outputs the result of the performed AND operation.

Specifically, if the output from the comparator is “1” and the read valid is “1”, the AND gate 24 outputs “1”. Otherwise, the AND gate 24 outputs “0”. In other words, the AND gate 24 outputs “1” if the memory controller 10 receives a read request and if the comparator 23 determines that the read address matches the patrol address of the subsequently issued patrol request.

The RS flip-flop 25 is a flip-flop that stores the output from the AND gate 24 as a cancel flag. Furthermore, the RS flip-flop 25 resets the stored value when the issuance interval timer 21 outputs a patrol valid via the route indicated by (P) in FIG. 4.

Specifically, if the output from the AND gate 24 is “1”, the RS flip-flop 25 stores, as a cancel flag, “1” that is input via the Set terminal thereof and then continuously outputs “1” via the Q terminal thereof. Furthermore, when the issuance interval timer 21 outputs “1” as a patrol valid, the RS flip-flop 25 resets the stored value and outputs “0” via the Q terminal.

In other words, the RS flip-flop 25 retains the patrol cancel flag if the patrol address of the subsequently issued patrol request matches the read address of each of the read requests that are received before the patrol address is issued. The RS flip-flop 25 then deletes the cancel flag when the issuance interval timer 21 issues a patrol valid, which will be explained later.

The OR gate 26 performs a logical OR operation on the value that is input via the Set terminal of the RS flip-flop 25 and the value that is output via the Q terminal of the RS flip-flop 25 and then outputs the result of the performed OR operation. Specifically, the OR gate 26 outputs “1” if the output from the AND gate 24 is “1” or the output from the RS flip-flop 25 is “1”. In other words, the OR gate 26 outputs “1” if the memory controller 10 receives a read request and the comparator 23 determines that the read address matches the patrol address of the subsequently issued patrol request or if the cancel flag is “1”.

Specifically, the OR gate 26 performs a logical OR operation on the output from the RS flip-flop 25 and the result of comparison that bypasses the RS flip-flop 25. Thus, the patrol control unit 11 is capable of canceling the issuance of a patrol request if the patrol address matches the read address for the read request that is received at the same time that the patrol request is issued.

The AND gate 27 receives an input of a patrol request that includes the patrol address and the patrol valid issued by the issuance interval timer 21 and receives the output from the OR gate 26 that is inverted before being input. When the output from the OR gate 26 is “1”, the AND gate 27 does not output a patrol request. When the output from the OR gate 26 is “0”, the AND gate 27 issues a patrol request to the arbiter 14 via the route indicated by (D) in FIG. 4.

Specifically, the AND gate 27 cancels a patrol request if a read request is received and the comparator 23 determines that the read address matches the patrol address for the subsequently issued patrol request or if the cancel flag is “1”. In other words, the AND gate 27 cancels the issuance of a patrol request if the read address of the read request that is received at the same time that the patrol request is issued matches the patrol address of the issued patrol request, or if the cancel flag is “1”.

FIG. 5 is a timing chart that illustrates the time in which the patrol control unit according to the first embodiment issues a patrol request. FIG. 5 illustrates the times in which the issuance interval timer 21 issues timing notifications and patrol valids and illustrates patrol addresses generated by the patrol-address generation unit 22. Furthermore, FIG. 5 illustrates the times in which read requests are received, the read addresses associated with the received read requests, the times in which cancel flags are stored in the RS flip-flop 25, and the time in which a patrol request is issued.

At T1 illustrated in FIG. 5, the patrol-address generation unit 22 stores the patrol address “0” and the issuance interval timer 21 issues a timing notification and a patrol valid. Therefore, the patrol control unit 11 issues a patrol request for the memory address “0”. Next, at T2 illustrated in FIG. 5, the patrol-address generation unit 22 generates the new patrol address “1”. Although the patrol control unit 11 receives the read request for the read address “3”, the patrol control unit 11 does not set a cancel flag as the read address does not match the patrol address.

Next, at T3 illustrated in FIG. 5, the memory controller 10 receives the read request for the read address “1”. The patrol control unit 11 then determines that the generated patrol address matches the read address and then stores the cancel flag “1” in the RS flip-flop 25 at T4 illustrated in FIG. 5. Furthermore, the memory controller 10 receives the read requests for the read addresses “2” and “8” at T4 and T5, respectively, illustrated in FIG. 5. Here, the patrol control unit 11 has already stored the cancel flag in the RS flip-flop 25 at T4 illustrated in FIG. 5 and, if the patrol control unit 11 acquires the read address that is different from the generated patrol address, retains the cancel flag without deleting it.

Although the patrol control unit 11 issues a timing notification and a patrol valid at T6 illustrated in FIG. 5, the patrol control unit 11 cancels the issuance of a patrol request as the cancel flag “1” is stored in the RS flip-flop 25. The patrol control unit 11 then resets the cancel flag stored in the RS flip-flop 25 to “0” at T7 illustrated in FIG. 5 and generates the new patrol address “2”.

The patrol control unit 11 performs the same process as the above-described process during the time period from T7 to T9 illustrated in FIG. 5. Here, at T10 illustrated in FIG. 5, the patrol control unit 11 issues a timing notification and a patrol valid, and the memory controller 10 receives the read request for the read address “2”.

As illustrated at T10 in FIG. 5, the patrol control unit 11 issues a timing notification and a patrol valid. At this time, as the patrol address matches the read address, the OR gate 26 bypasses the RS flip-flop 25 and inputs a cancel signal to the AND gate 27, thereby canceling the issuance of a patrol request. At T11 illustrated in FIG. 5, the patrol control unit 11 resets the cancel flag stored in the RS flip-flop 25 to “0” and generates the new patrol address “3”.

Thus, the patrol control unit 11 compares the patrol address of the subsequently issued patrol request with the read address of the read request that is received before the patrol request is issued. If the patrol address matches the read address, the patrol control unit 11 cancels the issuance of a patrol address. Furthermore, the patrol control unit 11 cancels the issuance of a patrol address if the patrol control unit 11 receives a read request for the read address that is identical to the patrol address of the patrol request at the same time that the patrol request is issued.

Here, when the memory controller 10 issues a read request, the data stored in the read address is read, and an error is detected and corrected by the error checker 17 and the error correction unit 18, which will be described later. Thus, even if the patrol control unit 11 receives a read request for the memory address that is identical to that for the subsequently issued patrol request and then cancels the patrol request, the rate at which uncorrectable errors occur would not be degraded. As a result, with the patrol control unit 11, the memory access rate in accordance with read requests can be improved without degrading the rate at which uncorrectable errors occur in data; thus, it is possible to prevent degradation in the system performance.

When the patrol control unit 11 receives, from the scrub control unit 13, a notification that the issuance of each request is prohibited, the patrol control unit 11 may use any method to stop issuing patrol requests. For example, a switch, such as a field-effect transistor (FET), may be provided on the route indicated by (D) in FIG. 4 and, when a notification that the issuance of each request is prohibited is received from the scrub control unit 13, the patrol control unit 11 may electrically disconnect the route indicated by (D) in FIG. 4.

Returning to FIG. 3, the buffer 12 is a buffer that receives read requests and write requests that are transmitted from the chip set 5 and temporarily stores them. For example, when the buffer 12 receives a read request from the chip set 5, the buffer 12 stores the received read request and issues a read request to the arbiter 14 via the route indicated by (F) in FIG. 3. When the buffer 12 receives, from the arbiter 14, “Taken” that indicates that the read request has been issued, the buffer 12 deletes the issued read request.

Furthermore, when the buffer 12 receives, from the scrub control unit 13, a notification that the issuance of each request is prohibited, the buffer 12 stops issuing the read request and write request that are received from the chip set 5. Moreover, when the buffer 12 receives, from the scrub control unit 13, a notification that the prohibition on issuance of each request is canceled, the buffer 12 restarts to issue read requests and write requests. The time in which the buffer 12 receives a read request, i.e., the time in which each of the CPUs 2 to 2b issues a read request is unrelated to the time in which a patrol request is issued; therefore, the buffer 12 irregularly receives read requests.

When the error checker 17 detects any error from the data read from the DIMMs 3 and 3a, the scrub control unit 13 performs a scrub operation to correct the error. Specifically, when the scrub control unit 13 receives, from the error checker 17, a notification that an error has been detected, the scrub control unit 13 transmits, to the patrol control unit 11 and the buffer 12, a notification that the issuance of each request is prohibited in order to ensure the coincidence of data.

As indicated by (G) in FIG. 3, the scrub control unit 13 then issues a scrub read request for the memory address from which the error checker 17 has detected an error. Here, the scrub control unit 13 is capable of, by using any method, acquiring the memory address from which the error checker 17 has detected an error. For example, the scrub control unit 13 acquires the memory address for a read request or patrol request from the arbiter 14. When the scrub control unit 13 receives, from the error checker 17, a notification that an error has been detected, the scrub control unit 13 may issue a scrub read request to the previously acquired memory address.

When the error checker 17 detects any error as a result of the issued scrub read request and the error correction unit 18 corrects the error, the scrub control unit 13 issues a scrub write request to the arbiter 14, as indicated by (G) in FIG. 3. Simultaneously, as indicated by (K) in FIG. 3, the scrub control unit 13 transmits, to the arbiter 19, a signal that prompts the selection of data that is input to the arbiter 19 from the error correction unit 18 via the route indicated by (I) in FIG. 3. Afterward, the scrub control unit 13 transmits, to the patrol control unit 11 and the buffer 12, a notification that the prohibition on issuance of each request is canceled.

The arbiter 14 is an arbiter that arbitrates among a patrol request issued by the patrol control unit 11, a read request or write request issued by the buffer 12, and a scrub read request or scrub write request issued by the scrub control unit 13. Specifically, the arbiter 14 arbitrates among the requests issued by the patrol control unit 11, the buffer 12, and the scrub control unit 13, where the requests are given priority in the following order: scrub read requests, scrub write requests, patrol requests, read requests, and then write requests. The arbiter 14 then issues, to the DIMMs 3 and 3a via the buffer 15, a command to execute the request that has won the arbitration, as indicated by (E) in FIG. 3.

Furthermore, the arbiter 14 notifies the route selection unit 28 of the details of the command that has been issued to the DIMMs 3 and 3a. Specifically, the arbiter 14 notifies the route selection unit 28 of the details of the issued command, i.e., whether it is a read request, patrol request, or scrub read request.

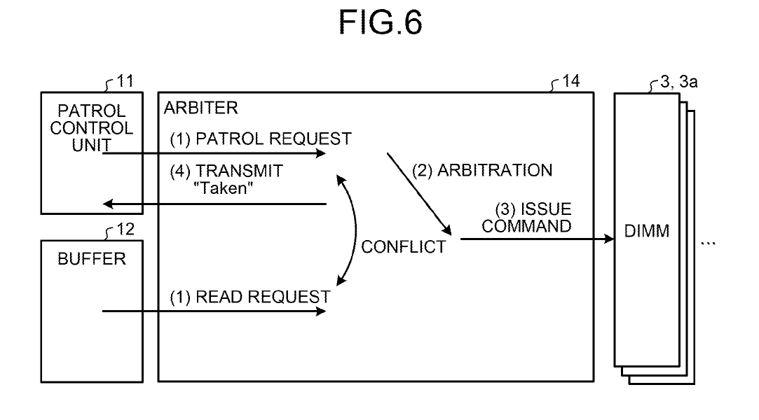

An explanation is given below, with reference to FIG. 6, of an example of the arbitration performed by the arbiter 14. FIG. 6 is a diagram that illustrates an example of the process performed by the arbiter according to the first embodiment. With the example illustrated in FIG. 6, an explanation is given of the process to arbitrate between a patrol request issued by the patrol control unit 11 and a read request issued by the buffer 12.

In the example illustrated in FIG. 6, the arbiter 14 receives the patrol request issued by the patrol control unit 11 and also receives the read request issued by the buffer 12 ((1) in FIG. 6). In such a case, as the patrol request conflicts with the read request, the arbiter 14 arbitrates between the patrol request and the read request ((2) in FIG. 6). Here, as the arbiter 14 gives priority to the issuance of the patrol request over the read request, the arbiter 14 issues, to the DIMMs 3 and 3a, the command to execute the patrol request ((3) in FIG. 6). The arbiter 14 then transmits, to the patrol control unit 11, “Taken” that indicates that the patrol request has been executed ((4) in FIG. 6).

As scrub read requests and scrub write requests are issued after the scrub control unit 13 prohibits the patrol control unit 11 and the buffer 12 from issuing requests, there is actually no conflict of them in the arbiter 14. However, in order to prevent the inconsistent state of the circuit being produced in the arbiter 14, the levels of priority are set to the arbiter 14 such that priority is given to scrub read requests and scrub write requests over other requests.

Read requests are continuously issued and therefore, if the level of priority of patrol requests is set to be lower than that of read requests, patrol requests are not performed at all. As a result, there is a higher possibility that uncorrectable errors occur in data stored in the DIMMs 3 and 3a; thus, priority is given to the execution of patrol requests over read requests.

The buffer 15 is a buffer that transmits a command issued by the arbiter 14 to the DIMMs 3 and 3a. The buffer 16 is part of a bidirectional buffer that includes the buffer 20. The buffer 16 controls the flow of data transmitted and received to and from the DIMMs 3 and 3a. Furthermore, the buffer 16 is a buffer that transmits data (hereafter, referred to as read data) read from the DIMMs 3 and 3a to the error checker 17 and the error correction unit 18 via the route indicated by (H) in FIG. 3. Here, an ECC is given to read data so that an error, such as bit inversion, is detected and corrected. The buffer 16 is installed so that data is prevented from flowing to the DIMMs 3 and 3a from the error checker 17 and the error correction unit 18.

The error checker 17 detects any error from the read data that is read from the DIMMs 3 and 3a. Specifically, the error checker 17 receives read data from the buffer 16. The error checker 17 uses the ECC that is attached to the received read data to determine whether any error occurs in the received read data. If the error checker 17 detects any error from the read data, the error checker 17 notifies the error correction unit 18 and the scrub control unit 13 that an error has been detected, as indicated by (J) in FIG. 3.

When the error correction unit 18 receives read data from the buffer 16 and also receives, from the error checker 17, a notification that an error has been detected, the error correction unit 18 uses the ECC that is attached to the read data received from the buffer 16 to correct the error. The error correction unit 18 then transmits, to the route selection unit 28, the read data in which the error has been corrected. If the error correction unit 18 does not receive, from the error checker 17, a notification that an error has been detected, the error correction unit 18 transmits the read data received from the buffer 16 to the route selection unit 28.

If the arbiter 19 does not receive any notification from the scrub control unit 13, the arbiter 19 receives the data that is transmitted from the chip set 5 via the route indicated by (N) in FIG. 3 and that is to be written in the DIMMs 3 and 3a. The arbiter 19 then transmits the received data to the buffer 20 via the route indicated by (L) in FIG. 3. Furthermore, when the arbiter 19 receives, from the scrub control unit 13, a notification that prompts the selection of the data that is input to the arbiter 19 via the route indicated by (I) in FIG. 3, the arbiter 19 receives the data that is received via the route indicated by (I) in FIG. 3, i.e., the data associated with a scrub read request. The arbiter 19 then transmits the received data to the buffer 20 via the route indicated by (L) in FIG. 3. Here, an ECC is attached to the data transmitted by the arbiter 19.

The buffer 20 transmits the data received from the arbiter 19 to the DIMMs 3 and 3a as write data. The buffer 20 is installed so that the data read from the DIMMs 3 and 3a is prevented from flowing to the arbiter 19.

The route selection unit 28 receives read data from the error correction unit 18. Furthermore, the route selection unit 28 receives, from the arbiter 14, a notification indicating whether the received read data has been read in response to a read request, patrol request, or scrub read request.

If the read data received from the error correction unit 18 is the read data that has been read in response to a read request, the route selection unit 28 transmits the received read data to the chip set 5 via the route indicated by (M) in FIG. 3. If the read data received from the error correction unit 18 is the read data that has been read in response to a patrol request, the route selection unit 28 discards the received read data. Furthermore, if the read data received from the error correction unit 18 is the read data that has been read in response to a scrub read request, the route selection unit 28 transmits the received read data to the arbiter 19 via the route indicated by (I) in FIG. 3.

For example, the memory controller 10, the patrol control unit 11, the scrub control unit 13, the arbiter 14, the error checker 17, the error correction unit 18, the arbiter 19, the route selection unit 28, the issuance interval timer 21, and the patrol-address generation unit 22 are electronic circuits. Here, integrated circuits, such as application-specific integrated circuits (ASICs) or field-programmable gate arrays (FPGAs), are used as examples of the electronic circuits. Furthermore, the buffer 12 is a storage device, for example, a semiconductor memory device, such as a random access memory (RAM) or flash memory.

Flow of Process Performed by the Memory Controller 10

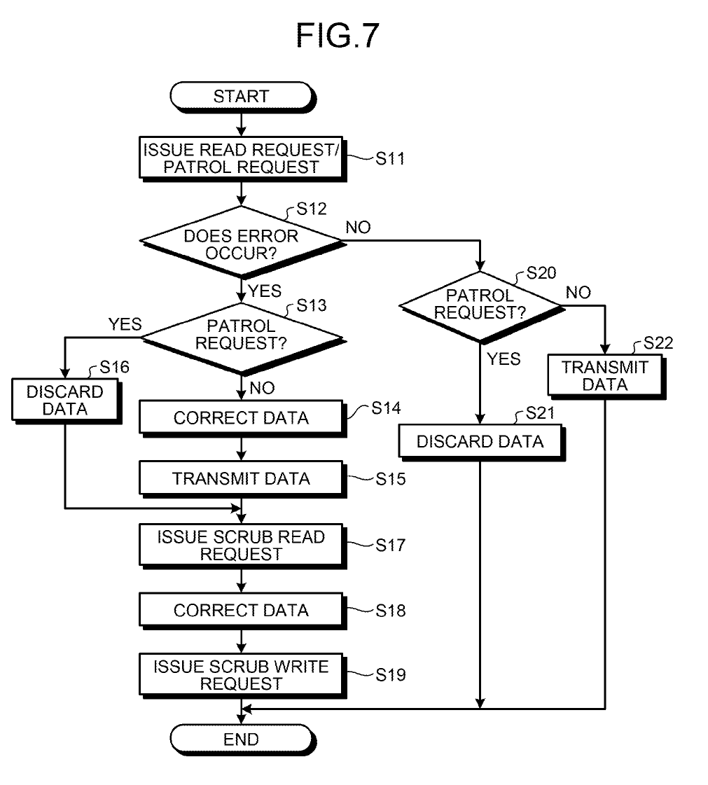

Next, an explanation is given, with reference to the drawing, of the flow of the process performed by the memory controller 10. First, an explanation is given, with reference to FIG. 7, of the process performed by the memory controller 10 to read data from the DIMMs 3 and 3a and correct the data. FIG. 7 is a flowchart that illustrates the flow of the process performed by the memory controller according to the first embodiment. In the example illustrated in FIG. 7, the memory controller 10 starts the process that is triggered when a read request is received from the chip set 5 or when it is time to issue a patrol request.

First, the memory controller 10 issues a read request or patrol request (Step S11). Next, the memory controller 10 determines whether any error occurs in the read data that is read from the DIMMs 3 and 3a (Step S12). If the memory controller 10 determines that an error occurs (Yes at Step S12), the memory controller 10 determines whether the read data is the data that has been read in response to a patrol request (Step S13).

If the memory controller 10 determines that the read data is not the read data that has been read in response to a patrol request (No at Step S13), the memory controller 10 corrects the error in the read data (Step S14). The memory controller 10 then transmits, to the chip set 5, the read data in which the error has been corrected (Step S15). Conversely, if the memory controller 10 determines that the read data is the read data that has been read in response to a patrol request (Yes at Step S13), the memory controller 10 discards the read data (Step S16).

The memory controller 10 then issues a scrub read request (Step S17) and corrects an error in the data read from the DIMMs 3 and 3a (Step S18). Afterward, the memory controller 10 issues a scrub write request (Step S19) so that the error-corrected data is stored in the DIMMs 3 and 3a. After the error-corrected data is stored in the DIMMs 3 and 3a, the memory controller 10 terminates the process.

If the memory controller 10 determines that no error has been detected (No at Step S12), the memory controller 10 determines whether the read data is the data that has been read in response to a patrol request (Step S20). If the memory controller 10 determines that the read data is the data that has been read in response to a patrol request (Yes at Step S20), the memory controller 10 discards the read data (Step S21) and terminates the process. Conversely, if the memory controller 10 determines that the read data is not the data that has been read in response to a patrol request (No at Step S20), the memory controller 10 outputs the read data to the chip set 5 (Step S22) and terminates the process.

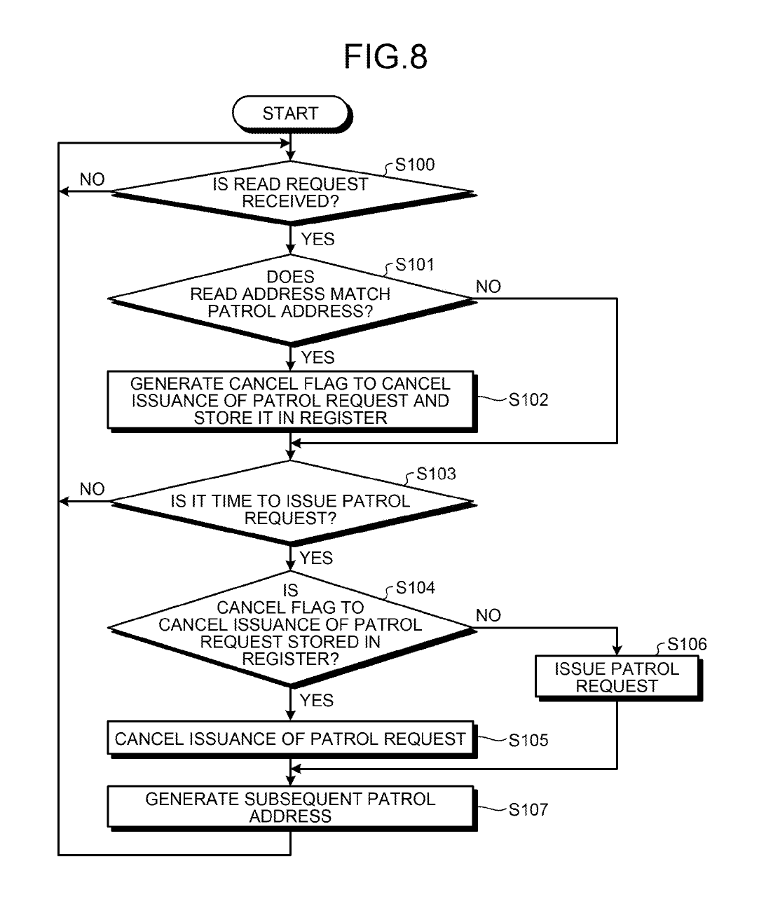

Next, an explanation is given, with reference to FIG. 8, of the process performed by the memory controller 10 to cancel the issuance of a patrol request if the read address of the received read request matches the generated patrol address as a result of comparison. FIG. 8 is a flowchart that illustrates the process performed by the memory controller according to the first embodiment to cancel a patrol request. In the flowchart of the process illustrated in FIG. 8, an explanation is given of the flow of the process that is obtained by generalizing the above-described first embodiment as appropriate.

In the example illustrated in FIG. 8, the memory controller 10 determines whether a read request is received (Step S100). The memory controller 10 starts the process that is triggered when a read request is received (Yes at Step S100). First, the memory controller 10 determines whether the read address of the received read request matches the generated patrol address (Step S101). If the memory controller 10 determines that the read address matches the patrol address (Yes at Step S101), the memory controller 10 performs the following operation. That is, the memory controller 10 generates a cancel flag to cancel the issuance of a patrol request and stores the generated cancel flag in a register, i.e., the RS flip-flop 25 (Step S102).

Next, the memory controller 10 determines whether it is time to issue a patrol request (Step S103). If it is time to issue a patrol request (Yes at Step S103), the memory controller 10 performs the following operation. That is, the memory controller 10 determines whether the cancel flag to cancel the issuance of a patrol request is stored in the register (Step S104).

If the memory controller 10 determines that the cancel flag is stored in the register (Yes at Step S104), the memory controller 10 cancels the issuance of a patrol request (Step S105). If the memory controller 10 determines that the cancel flag to cancel the issuance of a patrol request is not stored in the register (No at Step S104), the memory controller 10 issues a patrol request (Step S106).

Afterward, the memory controller 10 generates a patrol address for the subsequently issued patrol request (Step S107) and determines whether a read request is received again (Step S100). If no read request is received (No at Step S100), the memory controller 10 determines whether a read request is received again. Furthermore, if it is not time to issue a patrol request (No at Step S103), the memory controller 10 determines whether a read request is received (Step S100).

### Advantages of First Embodiment

As described above, the memory controller 10 generates a patrol address for the subsequently issued patrol request and issues a patrol request for the generated patrol address at a certain time interval. Furthermore, when the memory controller 10 receives a read request, the memory controller 10 compares the read address for the received read request with the generated patrol address. If the read address matches the patrol address, the memory controller 10 cancels the issuance of a patrol request. Thus, the memory controller 10 can prevent the interference with memory accesses in accordance with read requests without degrading the rate at which uncorrectable errors occur in data and can prevent degradation in the system performance.

Specifically, because patrol requests are checking read requests that are unrelated to operations of applications, or the like, that use data stored in the DIMMs 3 and 3a, the execution of read requests is interrupted due to an increase in the number of times patrol requests are issued and, as a result, the system performance is degraded. However, if the read address matches the patrol address, the memory controller 10 cancels the issuance of a patrol request. Therefore, as a result of read requests that are issued without being lost in the arbitration, the memory controller 10 can improve the memory access performance related to read requests and can prevent degradation in the system performance.

Furthermore, in the memory controller 10, if an error is detected from the read data that is read in response to a read request, the error is detected and corrected in accordance with a scrub read request and a scrub write request in the same manner as the read data that is read in response to a patrol request. Thus, if the memory controller 10 issues a read request for the memory address that is identical to the subsequently issued patrol address, it is possible to achieve the same effect as is the case where a patrol request is issued.

Accordingly, if the read address matches the patrol address, the memory controller 10 cancels the issuance of a patrol request; thus, it is possible to increase the DIMM access time without degrading the rate at which the system down occurs due to DIMM errors.

Furthermore, each time the memory controller 10 receives a read request, the memory controller 10 compares the read address of the received read request with the subsequently issued patrol address. If the read address matches the patrol address, the memory controller 10 cancels the issuance of a patrol request. Thus, even if read requests are continuously issued, the memory controller 10 is capable of appropriately canceling a patrol request.

### [b] Second Embodiment

In the following second embodiment, an explanation is given of a memory controller 10a that includes a patrol control unit that compares multiple memory addresses with a patrol address. The memory controller 10a has the same functionality and configuration as those of the memory controller 10 according to the first embodiment, and therefore an explanation thereof with reference to the drawings is omitted. Specifically, the memory controller 10a is the same as the memory controller 10 according to the first embodiment except that the memory controller 10a includes a patrol control unit 11a that corresponds to the patrol control unit 11.

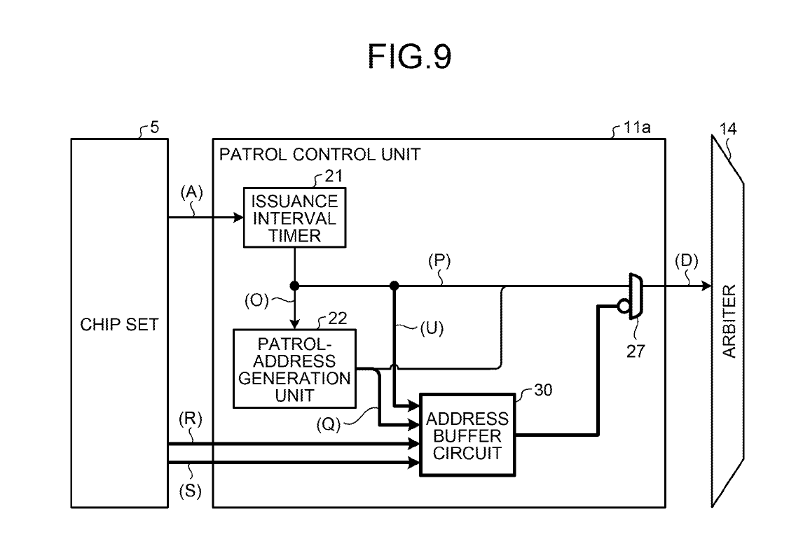

An explanation is given, with reference to FIG. 9, of the patrol control unit 11a that is included in the memory controller 10a. FIG. 9 is a diagram that illustrates the patrol control unit according to the second embodiment. In the example illustrated in FIG. 9, the same reference numerals and codes are assigned to the units that have the same functionality as those of the units illustrated in FIG. 4 and to the routes through which the same signals are transmitted and received as those of the routes illustrated in FIG. 4, and explanations thereof are omitted.

As illustrated in FIG. 9, the patrol control unit 11a includes an address buffer circuit 30. As indicated by (Q) in FIG. 9, the address buffer circuit 30 acquires a patrol address that is generated by the patrol-address generation unit 22. Furthermore, as indicated by (U) in FIG. 9, the address buffer circuit 30 acquires a patrol valid that is issued by the issuance interval timer 21. Moreover, as indicated by (S) in FIG. 9, the address buffer circuit 30 acquires a read command. Moreover, as indicated by (R) in FIG. 9, the address buffer circuit 30 acquires a read address.

The address buffer circuit 30 includes a plurality of storage units that is capable of storing the read addresses for read requests for a certain period of time. When the address buffer circuit 30 receives a patrol valid, the address buffer circuit 30 compares the patrol address with the read address that is stored in each of the storage units. If the read address stored in any of the storage units matches the patrol address, the address buffer circuit 30 then inputs “1” to the AND gate 27 in an inverted manner, thereby canceling the issuance of a patrol request.

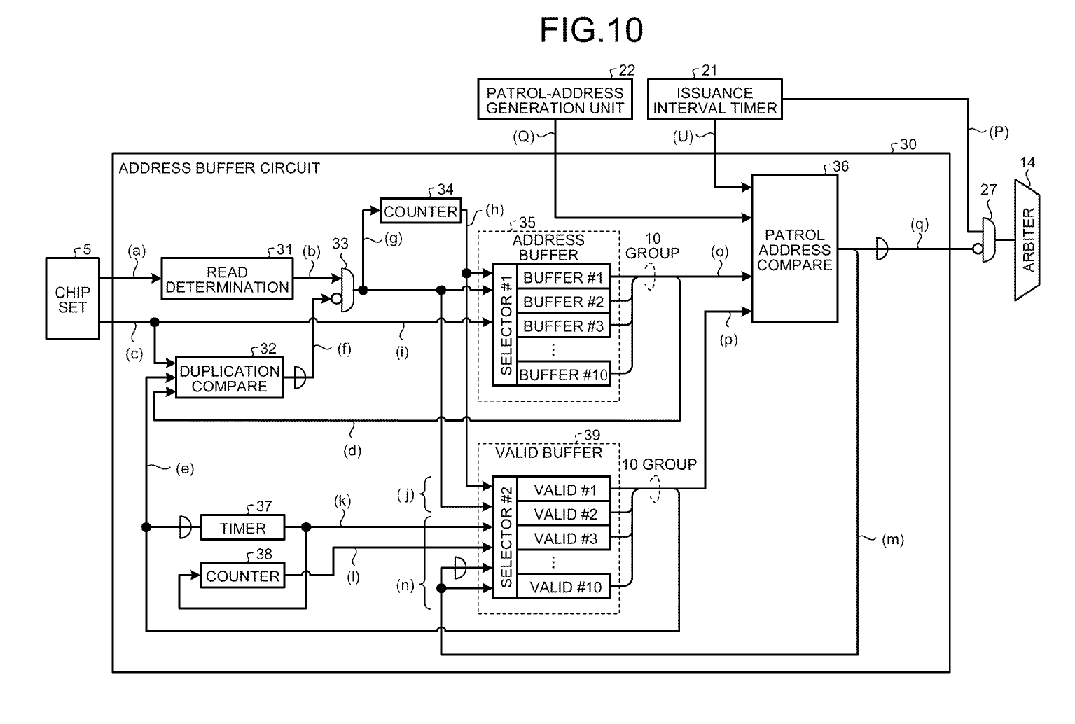

An explanation is given below, with reference to the drawing, of a specific example of the address buffer circuit 30. FIG. 10 is a diagram that illustrates an example of the address buffer circuit according to the second embodiment. The route indicated by (a) in FIG. 10 corresponds to the route indicated by (s) in FIG. 9, and the route indicated by (c) in FIG. 10 corresponds to the route indicated by (R) in FIG. 9. Furthermore, the routes indicated by (P), (Q), and (U) in FIG. 10 correspond to the routes indicated by (P), (Q), and (U) in FIG. 9.

In the example illustrated in FIG. 10, the address buffer circuit 30 includes a read determination 31, a duplication compare 32, an AND gate 33, a counter 34, and an address buffer 35. The address buffer circuit 30 further includes a patrol address compare 36, a timer 37, a counter 38, and a valid buffer 39.

The address buffer 35 includes a selector #1 and ten buffers #1 to #10. The valid buffer 39 includes a selector #2 and ten valids #1 to #10. Each of the buffers #1 to #10 corresponds to any one of the valids #1 to #10. The read address that is the subject of a read request is stored in each of the buffers #1 to #10, and a valid bit is stored in any of the valids #1 to #10 that corresponds to the buffer that stores a read address. That is, the valid bit indicates a valid read address.

The read determination 31 receives a read command or write command via the route indicated by (a) in FIG. 10. If the received command is a read command, the read determination 31 outputs a valid bit and inputs it to the AND gate 33 via the route indicated by (b) in FIG. 10. The read determination 31 does not output a valid bit if the read determination 31 receives a write command.

Here, if the read determination 31 does not output a valid bit, a read address is not stored in any of the buffers #1 to #10. Therefore, in the following explanation, it is assumed that the patrol control unit 11a acquires a read command and a read address.

The duplication compare 32 acquires a read address via the route indicated by (c) in FIG. 10. Furthermore, the duplication compare 32 acquires, via the route indicated by (d) in FIG. 10, the read address that is stored in each of the buffers #1 to #10 of the address buffer 35. Moreover, the duplication compare 32 acquires, via the route indicated by (e) in FIG. 10, the valid bit that is stored in each of the valids #1 to #10 of the valid buffer 39.

The duplication compare 32 compares the received read address with the read address stored in any of the buffers #1 to #10 that is related to the valid that stores the valid bit. If the received read address matches any of the read addresses, the duplication compare 32 outputs “1” to the AND gate 33 via the route indicated by (f) in FIG. 10. Here, the AND gate 33 acquires the output from the duplication compare 32 in an inverted manner.

Thus, if the received read address is identical to the read address stored in the address buffer 35, the duplication compare 32 cancels the storage of the newly received read address. As a result, with the address buffer circuit 30, it is possible to reduce the size of the address buffer 35 and the valid buffer 39, to reduce the size of the circuit, and to simplify the circuit configuration.

When the duplication compare 32 outputs “0”, the AND gate 33 outputs the valid bit that is output from the read determination 31. When the duplication compare 32 outputs “1”, the AND gate 33 does not output the valid bit that is output from the read determination 31. The AND gate 33 transmits a valid bit to the selector #1 of the address buffer 35 and the selector #2 of the valid buffer 39. The valid bit transmitted to the selectors #1 and #2 by the AND gate 33 is used as a write enable signal.

When the counter 34 receives a valid bit via the route indicated by (g) in FIG. 10, the counter 34 selects, from the buffers #1 to #10 included in the address buffer 35, the buffer that stores the read address of the received read request. For example, the counter 34 is a counter that repeatedly counts a numerical value from “1” to “10”. When the counter 34 receives a valid bit, the counter 34 increments the value of the counter by “1”.

The counter 34 then transmits the value of the counter to the selector #1 of the address buffer 35 and the selector #2 of the valid buffer 39 via the route indicated by (h) in FIG. 10. An explanation is given by using a specific example. When the counter 34 acquires a valid bit while the value of the counter is “4”, the counter 34 sets the value of the counter to “5” and transmits the value “5” of the counter to the selector #1 of the address buffer 35 and the selector #2 of the valid buffer 39.

The selector #1 acquires a read address via the route indicated by (i) in FIG. 10. Furthermore, the selector #1 acquires the value of the counter 34 via the route indicated by (h) in FIG. 10. When the selector #1 receives a valid bit, i.e., a write enable signal, from the AND gate 33, the selector #1 stores the received read address in the buffer that is indicated by the value of the counter 34. For example, when the selector #1 receives a read address and a write enable signal while receiving “5” from the counter 34, the selector #1 stores the read address in the buffer #5. That is, the selector #1 stores a read address in the buffer that is related to the valid that does not store a valid bit.

When the selector #2 acquires the value of the counter 34 via the route indicated by (h) in FIG. 10 and also receives a valid bit, i.e., a write enable signal, from the AND gate 33, the selector #2 performs the following operation. Specifically, the selector #2 stores a valid bit in the valid that is indicated by the value received from the counter 34. For example, when the selector #2 acquires “5” from the counter 34 and acquires a valid bit from the AND gate 33, the selector #2 stores the valid bit in the valid #5. The connection indicated by (j) in FIG. 10 represents the signal path for setting each of the valids #1 to #10 included in the valid buffer 39.

When a predetermined time has elapsed after a read address is stored in any of the buffers #1 to #10, the timer 37 deletes the valid bit stored in the valid that is related to the buffer that stores the read address. For example, when a valid bit is stored in any of the valids #1 to #10 included in the valid buffer 39, the timer 37 starts to count. When the counted value becomes a predetermined value, the timer 37 outputs a valid bit through the route indicated by (k) in FIG. 10.

When a valid bit is output through the route indicated by (k) in FIG. 10, the counter 38 selects, from the valids #1 to #10 included in the valid buffer 39, the valid from which the valid bit is to be deleted. For example, the counter 38 is a counter that repeatedly counts the numerical value from “1” to “10” as is the case with the counter 34. When the counter 38 acquires a valid bit, the counter 38 increments the value of the counter by “1”.

The counter 38 transmits the value of the counter to the selector #2 of the valid buffer 39 via the route indicated by (1) in FIG. 10. An explanation is given by using a specific example. When the timer 37 outputs a valid bit while the value of the counter is “4”, the counter 38 sets the value of the counter to “5” and transmits the value “5” of the counter to the selector #2 of the valid buffer 39. If no valid bit is stored in any of the valids #1 to #10, the timer 37 and the counter 38 stop counting and incrementing.

In addition to the above-described operation, when the selector #2 receives a valid bit via the route indicated by (k) in FIG. 10 and receives the value of the counter via the route indicated by (1) in FIG. 10, the selector #2 deletes the valid bit that is stored in the valid indicated by the value of the counter. For example, when the selector #2 receives a valid bit via the route indicated by (k) in FIG. 10 and receives “5” via the route indicated by (1) in FIG. 10, the selector #2 deletes the valid bit that is stored in the valid #5.

Specifically, the selector #2 deletes the valid bit that is stored in the valid #5 so as to make invalid the read address that is stored in the buffer #5 included in the address buffer 35. In other words, the counter 38 deletes a valid bit when a predetermined time has elapsed after the valid bit is stored. As described above, the subject from which a valid bit is to be deleted is selected by using incrementally generated values; therefore, even if there is an isolated valid bit among the valid bits stored in the valids #1 to #10, the isolated valid bit is deleted, whereby the circuit is simplified.

Furthermore, when the selector #2 receives a signal from the patrol address compare 36 via the route indicated by (m) in FIG. 10, the selector #2 deletes the valid bit that is stored in each of the valids #1 to #10 included in the valid buffer 39. Multiple connections indicated by (n) in FIG. 10 are the signal lines for deleting the valid bit stored in each of the valids #1 to #10.

The patrol address compare 36 acquires a patrol address via the route indicated by (Q) in FIG. 10. Furthermore, the patrol address compare 36 acquires the read address that is stored in each of the buffers #1 to #10 included in the address buffer 35 via the route indicated by (o) in FIG. 10. Moreover, the patrol address compare 36 acquires the valid bit that is stored in each of the valids #1 to #10 included in the valid buffer 39 via the route indicated by (p) in FIG. 10. The patrol address compare 36 continuously acquires patrol addresses, read addresses, and valid bits.

When the patrol address compare 36 receives a patrol valid via the route indicated by (U) in FIG. 10, the patrol address compare 36 performs the following operation. Specifically, the patrol address compare 36 compares the patrol address with one or more read addresses that are stored in any of the buffers #1 to #10, where such buffers are related to the valids that store the valid bits. If the read address matches the patrol address, the patrol address compare 36 inputs “1” to the AND gate 27 via the route indicated by (q) in FIG. 10. That is, if the read address matches the patrol address, the patrol address compare 36 cancels the issuance of a patrol request.

For example, the function of the patrol address compare 36 can be performed as set forth below. For instance, each of the buffers #1 to #10 is connected to any one of the valids #1 to #10 via an XOR gate, whereby only the read address stored in the buffer that is related to the valid that stores a valid bit is valid. The outputs from the ten XOR gates and the patrol address are compared by a comparator and the ten comparison results are grouped together by an OR gate, whereby a signal to be output from the patrol address compare 36 can be generated.

For example, the read determination 31, the duplication compare 32, the counters 34 and 38, the patrol address compare 36, and the timer 37 are electronic circuits. Here, integrated circuits, such as application-specific integrated circuits (ASICs) or field-programmable gate arrays (FPGAs), are used as examples of the electronic circuits. Furthermore, the address buffer 35 and the valid buffer 39 are storage devices, for example, semiconductor memory devices, such as random access memories (RAMs) or flash memories.

Flow of Process Performed by the Patrol Control Unit 11a

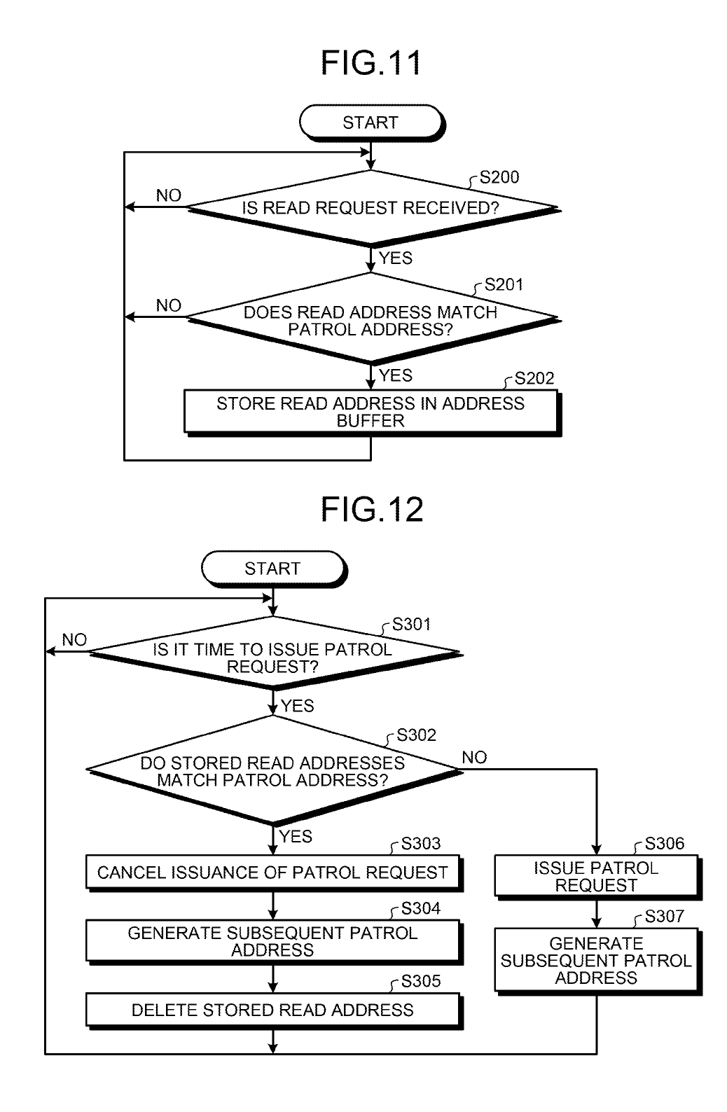

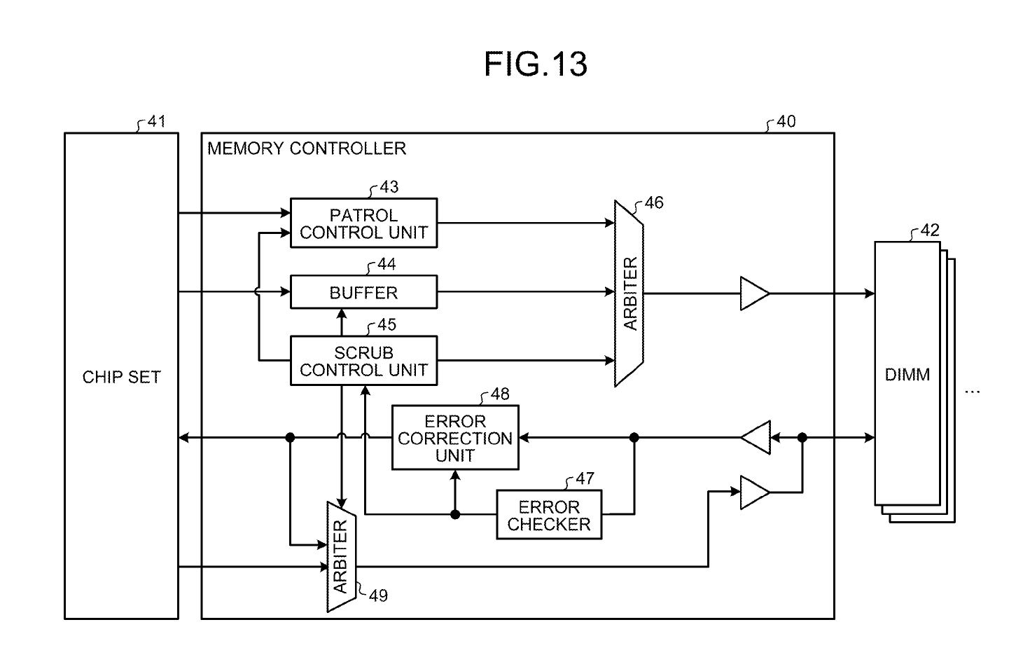

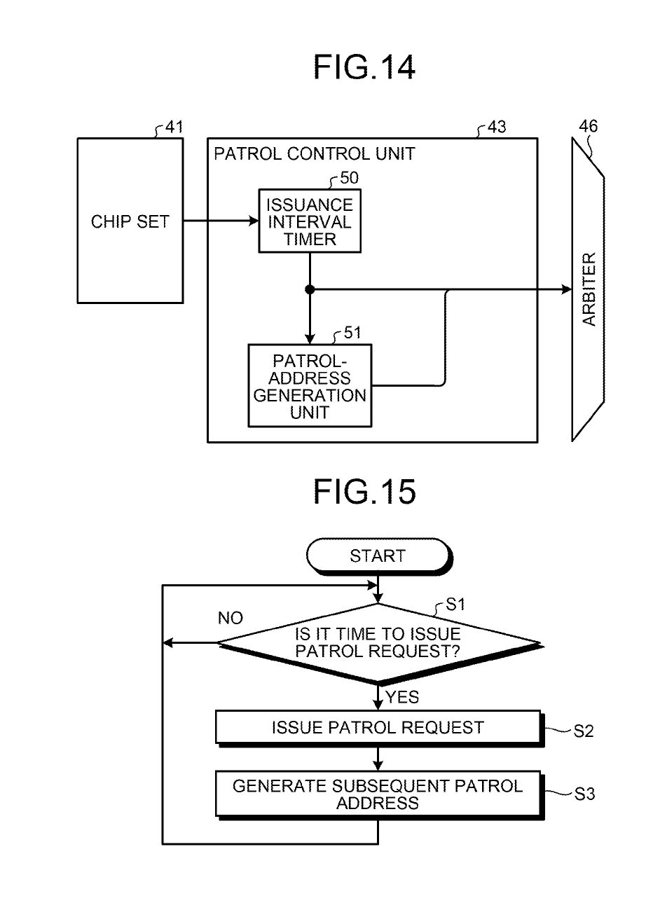

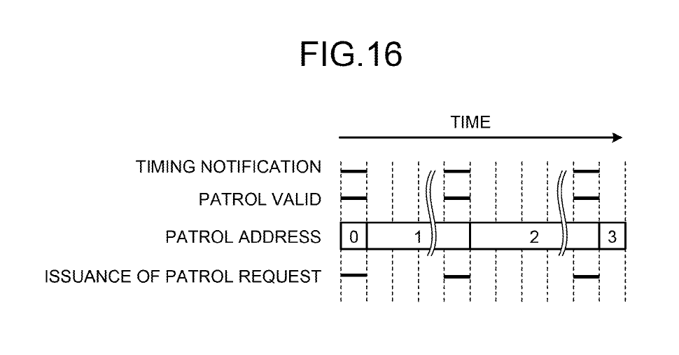

Next, an explanation is given, with reference to the drawing, of the flow of the process performed by the patrol control unit 11a. First, an explanation is given, with reference to FIG. 11, of an example of the flow of the process performed by the patrol control unit 11a to store a read address in the buffer. FIG. 11 is a chart that illustrates an example of the flow of the process performed by the patrol control unit according to the second embodiment to store a read address in the buffer.

In the example illustrated in FIG. 11, the patrol control unit 11a starts the process that is triggered when a read request is received (Yes at Step S200). First, the patrol control unit 11a determines whether the read address of the received read request matches the patrol address generated by the patrol-address generation unit 22 (Step S201). When the patrol control unit 11a determines that the read address matches the patrol address (Yes at Step S201), the patrol control unit 11a stores the read address in the address buffer 35 (Step S202). When the patrol control unit 11a determines that the read address does not match the patrol address (No at Step S201), the patrol control unit 11a does not store the read address, but determines whether a new read request is received (Step S200).

Next, an explanation is given, with reference to FIG. 12, of the flow of the process performed by the patrol control unit 11a to compare the patrol address with the stored read address so as to determine whether the patrol is to be canceled. FIG. 12 is a chart that illustrates an example of the flow of the process performed by the patrol control unit according to the second embodiment to determine whether the issuance of a patrol request is to be canceled. The patrol control unit 11a performs the process illustrated in FIG. 12 separately from the process illustrated in FIG. 11.

In the example illustrated in FIG. 12, the patrol control unit 11a determines whether it is time to issue a patrol request (Step S301). Next, if the patrol control unit 11a determines that it is time to issue a patrol request (Yes at Step S301), the patrol control unit 11a determines whether the stored read addresses match the patrol address (Step S302).

When the patrol control unit 11a determines that any of the stored read addresses matches the patrol address (Yes at Step S302), the patrol control unit 11a cancels the issuance of a patrol request (Step S303). Next, the patrol control unit 11a generates a patrol address of the subsequently issued patrol request (Step S304) and deletes the read address stored in the address buffer 35 (Step S305). Afterward, the patrol control unit 11a determines whether it is time to issue a patrol request again (Step S301).

When the patrol control unit 11a determines that none of the stored read addresses match the patrol address (No at Step S302), the patrol control unit 11a issues a patrol request (Step S306). Afterward, the patrol control unit 11a generates a patrol address for the subsequently issued patrol request (Step S307) and determines whether it is time to issue a patrol request again (Step S301). When the patrol control unit 11a determines that it is not time to issue a patrol request (No at Step S301), the patrol control unit 11a determines whether it is time to issue a patrol request again (Step S301).

### Advantages of Second Embodiment

As described above, the memory controller 10a includes the buffers #1 to #10 and the valids #1 to #10 that are related to the buffers #1 to #10. The memory controller 10a stores the read address in any one of the buffers #1 to #10. Furthermore, the memory controller 10a compares the generated patrol address with the read address that is stored in each of the buffers #1 to #10 when a patrol request is issued. When any of the read addresses matches the generated patrol address, the memory controller 10a cancels the issuance of a patrol request.

Specifically, the memory controller 10a cancels the issuance of a patrol request if the period during which the read request for the read address that is identical to the patrol address is issued is longer than the period during which a patrol request is issued. Therefore, the memory controller 10a prevents the interference with the DIMM accesses in accordance with read requests while preventing the occurrence of DIMM errors, thereby performing memory accesses in accordance with read requests and write requests in a smooth manner.

Moreover, the memory controller 10a includes the valids #1 to #10 that are related to the buffers #1 to #10 and stores a valid bit in the valid that is related to the buffer that stores the read address. The memory controller 10a then compares the patrol address with the read address that is stored in any of the buffers #1 to #10, where such buffer is related to the valid that stores a valid bit. Thus, the memory controller 10a is capable of easily updating the read address that is stored in each of the buffers #1 to #10.

Furthermore, the memory controller 10a deletes the stored valid bit when a predetermined time has elapsed after the valid bit is stored. Specifically, when a predetermined time has elapsed after a read address is stored in the buffer, the memory controller 10a makes the read address invalid and does not compare it with the patrol address. Thus, the memory controller 10a is capable of comparing multiple read addresses with a patrol address by using a simple circuit configuration.

Specifically, the memory controller 10a performs an exclusive OR operation on each of the buffers #1 to #10 and each of the valids #1 to #10, for example, an exclusive OR operation on the output of buffer #1 and the valid #1 or an exclusive OR operation on the buffer #2 and the valid #2. The memory controller 10a then performs a logical OR operation on the results of the exclusive OR operations, thereby acquiring a result of the determination as to whether the patrol address matches the read addresses of the read requests that are received during a predetermined time. Thus, the memory controller 10a is capable of comparing the read address with the patrol address by using a simple circuit configuration.

Moreover, if the read address for the newly received read request has been stored in any of the buffers, the memory controller 10a does not store the read address for the newly received read request. Thus, with the memory controller 10a, it is possible to reduce the size of the address buffer 35 and the valid buffer 39.

Specifically, in the commonly used system, read requests are successively issued to the same memory address. Here, if the read requests for the same memory address are successively issued, the memory controller 10a does not repeatedly store the read address for the subsequent read request, but discards it. Thus, with the memory controller 10a, it is possible to reduce the size of the address buffer 35 and the valid buffer 39.

Even if the memory controller 10a does not repeatedly store the read address for the subsequent read request, the memory controller 10 reads data in accordance with the previously received read request. As a result, the memory controller 10a detects and corrects an error in the read data, whereby the occurrence of uncorrectable errors can be prevented.

If the memory controller 10a stores the read address that is identical to the patrol address at the same time that the patrol request is issued, the memory controller 10a cancels the patrol request and also cancels a subsequent patrol request by using the stored read address. Specifically, if the memory controller 10a receives the read address for the read request that is for the same memory address at the same time that the patrol request is issued, the memory controller 10a does not output a patrol request for this memory address for two cycles.

However, the memory controller 10a issues a read request and, as a result, if an error occurs, the memory controller 10a issues a scrub read request and a scrub write request so as to correct the error; therefore, it is possible to prevent uncorrectable errors.

### Third Embodiment

Although the embodiments of the present invention have been described above, the embodiments may be embodied in various different forms other than the embodiments described above. In the following, another embodiment included in the present invention will be explained as a third embodiment.

(1) With Regard to Buffers

The above-described address buffer circuit 30 includes the address buffer 35 including the ten buffers #1 to #10 and the valid buffer 39 including the ten valids #1 to #10. However, this is not a limitation in the embodiment. The address buffer 35 may have any number of buffers, and the valid buffer 39 may have any number of valids.

Although the address buffer circuit 30 has the address buffer 35 and the valid buffer 39 as different buffers, this is not a limitation in the embodiment. For example, the address buffer 35 may have a plurality of buffer lines in which a read address and a valid bit are stored, and the address buffer 35 may perform the above-described operation by using the read address and the valid bit that are stored in each of the buffer lines.

(2) With Regard to System Board

The above-described memory controller 10 is mounted on the bridge chip 4 that is installed on the system board 1. However, this is not a limitation in the embodiment. For example, the memory controller 10 may be installed within each of the CPUs 2 to 2b. Specifically, the memory controller 10 may be installed within not only the bridge chip 4 but also any device that accesses the DIMM.

According to the embodiments, it is possible to perform memory accesses in accordance with read requests and write requests in a smooth manner and to improve the system performance.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A memory control device comprising:
a receiving unit that receives a read request for data that is stored in a storage device; and
a checking read request issuing unit that issues a checking read request at a predetermined time interval to request the data to be read so as to determine whether an error occurs in the data stored in the storage device,
the checking read request issuing unit including
an address generation unit that generates a memory address that is a subject of a subsequently issued checking read request;
an issuing unit that issues a checking read request for the memory address generated by the address generation unit at a predetermined time interval;
an address acquisition unit that acquires a memory address that is a subject of a read request received by the receiving unit; and
a canceling unit that compares the memory address generated by the address generation unit with the memory address acquired by the address acquisition unit and, when the memory addresses match, causes the issuing unit to cancel issuance of a checking read request for the memory address.

2. The memory control device according to claim 1, wherein
the address acquisition unit acquires a memory address that is a subject of a read request each time the receiving unit receives the read request, and
each time the address acquisition unit acquires the memory address, the canceling unit compares the memory address that is the subject of the read request with the memory address generated by the address generation unit.

3. The memory control device according to claim 1, wherein
the checking read request issuing unit further includes:
a plurality of address storage units that stores memory addresses acquired by the address acquisition unit for a certain period of time; and
an address retaining unit that retains a memory address acquired by the address acquisition unit in any of the address storage units, wherein
the canceling unit compares the memory address generated by the address generation unit with a memory address stored in each of the address storage units and, when the memory address generated by the address generation unit matches any of the memory addresses stored in the address storage units, causes the issuing unit to cancel issuance of a checking read request for the memory address.

4. The memory control device according to claim 3, wherein
the checking read request issuing unit further includes:
a plurality of valid storage units, each of the valid storage units being related to any of the address storage units;
a valid retaining unit that retains a valid bit in the valid storage unit that is related to the address storage unit in which the memory address is retained by the address retaining unit; and
a valid-bit deletion unit that deletes a valid bit when a predetermined time has elapsed after the valid bit is retained by the valid retaining unit, wherein
the address retaining unit retains the memory address in the address storage unit that is related to the valid storage unit that does not store the valid bit, and
the canceling unit compares the memory address generated by the address generation unit with the memory address that is stored in the address storage unit that is related to the valid storage unit that stores the valid bit.

5. The memory control device according to claim 3, wherein, when a memory address that is identical to a memory address newly acquired by the address acquisition unit has been already stored in any of the address storage units, the address retaining unit does not retain the newly acquired memory address in the address storage unit.

6. The memory control device according to claim 1, wherein the address generation unit generates a different memory address each time.

7. A control method in a control device that issues a checking read request at a predetermined time interval to request data stored in a storage device to be read so as to determine whether an error occurs in the data, the control method comprising:
receiving a read request for data stored in the storage device;
acquiring a memory address that is a subject of the received read request;
generating a memory address that is a subject of a subsequently issued checking read request; and
comparing the generated memory address with the acquired memory address and, when the memory addresses match, causing issuance of a checking read request for the memory address to be canceled.
